(19) United States
(12) Patent Application Publication
(10) Pub. No.: US 2010/0328539 A1
(43) Pub. Date: Dec. 30, 2010

(54) METHOD AND APPARATUS FOR MEMORY REUSE IN IMAGE PROCESSING

(75) Inventors: Yan HUO, Shenzhen (CN); Lu WANG, Guangdong (CN); Ka Man CHENG, Kowloon (HK); Xiao ZHOU, New Territories (HK)

Correspondence Address: CONLEY ROSE, P.C.;David A. Rose, P. O. BOX 3267, HOUSTON, TX, 77253-3267, US

(73) Assignee: Hong Kong Applied Science and Technology Research Institute Company Limited, Shatin (HK)

(21) Appl. No.: 12/493,931

(22) Filed: Jun. 29, 2009

(51) Int. Cl. H04N 5/00

(52) U.S. Cl. 348/718; 348/E05.001

(57) ABSTRACT

This invention relates to a method of reusing data in memory for motion estimation. Only additional data is required to prepare reference block so as to reduce the data transfer to the memory. The additional data will be arranged with the existing data in the memory to provide the reference block. Then the data in the memory is read in a specific way to retrieve the reference block. Using this invention, the bandwidth requirement and internal memory can be greatly reduced without any additional logic operation.

### TECHNICAL FIELD

The claimed invention relates generally to image/video signal processing. In particular, the claimed invention relates to motion estimation. The claimed invention is particularly applicable to motion estimation with a fixed search range. Furthermore, the claimed invention relates to how data is loaded into memory and retrieved from memory to make data reuse in a memory possible. Direct Memory Access (DMA) adopts this claimed invention to perform data loading more efficiently.

### SUMMARY OF THE INVENTION

A processor such as the CPU (Central Processing Unit) needs to load data from external memory to its internal memory for processing or performing instructions. External memory refers to any memory apart from the internal memory including other peripherals or any input/output devices.

A core unit of the processor manages data transfer. Or, in order to lower the workload of the core unit, a Direct Memory Access (DMA) controller is dedicated to manipulating the data transfer from anywhere in a system to an internal memory.

Data transfer from one place to another takes time. Since the processor needs to wait for the data before performing any action, the overall processing time of the processor is increased, resulting in undesirable delay. Furthermore, in video processing, the sheer size of video data makes the delay worse. If there is less data transferred, the processing time of the processor decreases and the performance of the processor is enhanced.

The claimed invention reduces data transfer if the required data exists in the internal memory, making reuse of data possible. Internal memory holds data processed in a current processing step. If the same data are required in both the current processing step and a subsequent processing step, data in internal memory are reused rather than reloaded from external memory. The reuse of data is possible, for example, in image/video processing.

For example, in motion estimation, a frame in a video is required for processing. The frame is divided into a number of blocks and processed block by block. The processor needs to work on a reference block which is a search range for a block. When the processor needs to work on next block which is adjacent to the block under processing, the search range for next block largely overlaps with the search range of the block under processing. Therefore, reusing the data is possible in this case, and the overlapping region between neighboring reference blocks need not be reloaded.

If the internal memory has a limited size, only two reference blocks—the current one under processing and the next one—are loaded into the memory at a time. The processing is performed in an order that all blocks in one row of an image are processed before the blocks in the next rows are processed.

If the internal memory has an abundant size, reference blocks of one or more rows in an image are loaded into the memory at the same time. Since reference blocks for multiple rows are available in the memory, the processing is performed in an order that blocks along the same columns are processed first before blocks in the next columns are processed. This provides an even more efficient memory loading because more data in the memory are reused and lower bandwidth is required.

It is an object of this invention to address and fulfill low bandwidth when it is a requirement.

It is a further object of this invention to enable the implementation of small internal memory.

It is a further object of this invention to provide a solution suitable for motion estimation algorithm with fixed search range.

It is a further object of this invention to provide a better method for data reuse of motion estimation and a method of innovative loading of reference block.

It is a further object of this invention to employ a data reuse method for blocking matching motion estimation to decrease the SDRAM width.

It is a further object of this invention to provide bandwidth reduction to both encoder and decoder.

Other aspects of the claimed invention are also disclosed.

### BRIEF DESCRIPTION OF THE DRAWINGS

These and other objects, aspects and embodiments of this claimed invention will be described hereinafter in more details with reference to the following drawings, in which:

FIG. 1 shows a flow diagram of how data in memory is reused and how data is loaded into memory.

FIG. 2A shows a portion of a frame divided into blocks.

FIG. 2B shows an embodiment of how data is reused and loaded into an internal memory.

FIG. 3 shows an embodiment of how data is reused and loaded into an internal memory.

FIG. 4 shows an embodiment of how data is reused and loaded into an internal memory.

FIG. 5 shows an embodiment of how data is reused and loaded into an internal memory.

FIG. 6A shows a portion of a frame divided into blocks.

FIG. 6B shows an embodiment of how data is reused and loaded into an internal memory.

FIG. 7 shows a device which implements the method of memory usage as described above.

### DETAILED DESCRIPTION OF THE INVENTION

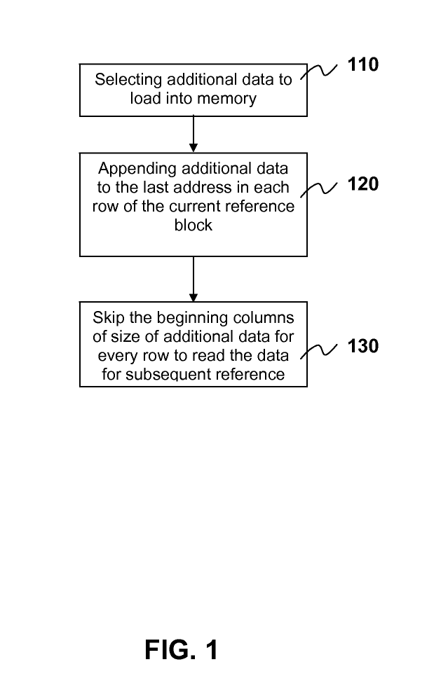

FIG. 1 shows a flow diagram of how the existing data in a memory are reused and how to load additional data into the memory. In an embodiment such as video processing, a processor processes one block after another block. Each block corresponds to a reference block (also known as a search range) in a reference frame. A reference frame normally is a frame prior to the frame of the block under processing.

A current block is the block being processed by a processor. A subsequent block is the block to be processed by a processor. A current reference block corresponds to the current block and has to be present in the memory when processing the current block. A subsequent reference block corresponds to the reference block and has to be present in the memory when processing the subsequent block.

If a current reference block exists in the internal memory and part or all of the current reference block is the same as the subsequent reference block, it is not necessary to transfer the whole subsequent reference block to the internal memory. Only additional reference data are selected from the reference frame for loading into the internal memory in a selecting step 110.

Because the subsequent block is a block adjacent to the current block, the displacement between the current block and the subsequent block is a block width in the horizontal direction. The subsequent reference block is an image region displaced by a block width from the current reference block. Therefore, the additional reference data are the image region appending to the last column of the current reference block with number of columns equal to a block width.

In a loading step 120, the additional reference data are appended to the last address of each row of the current reference block. The additional reference data is loaded into the primary memory with a fixed address displacement from the start address of the current reference block. The data address in each reference row is continuous, and there is a fixed address displacement between the neighboring reference rows. For reading every row of the subsequent reference block, the first few columns of a block width of the current reference block are skipped and perform a raster scan for a length of a row of the reference block to retrieve a row of the subsequent reference block.

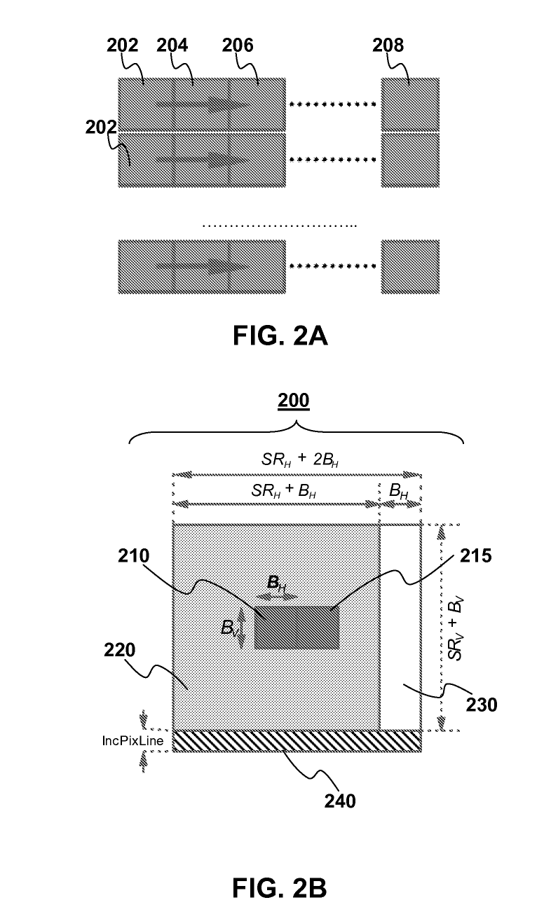

FIG. 2A shows a portion of a frame divided into blocks. An example of a frame is an image with a size of X pixels by Y pixels. In this case, a frame has Y rows of pixels and each row contains X pixels. A frame is processed block by block. An example of a block is an image with a size of B_{H} pixels by B_{V} pixels, whereas B_{H} is smaller than X and B_{V} is smaller than Y. A row of a frame has N blocks starting from a first block 202, a second block 204, a third block 206 . . . to an N^{th} block 208, in which X=N*B_{H}, Y=M*B_{V}. In an embodiment, blocks in each row of a frame are processed in the following sequence: a first block 202, a second block 204, a third block 206 . . . to an N^{th} block 208 before proceeding to process blocks in next row, starting from the first block again.

FIG. 2B shows how an image is loaded into a memory 200. In an embodiment, there is a first block 210 in an image. The first block 210 needs to be processed, and a first reference block 220 corresponding to the first block 210 is required to be loaded into the memory 200 for processing. Given that the size of the first block 210 is B_{H} by B_{V}, the size of the first reference block 220 is SR_{H}+B_{H} by SR_{V}+B_{V}. SR_{H} determines the search range in the horizontal direction and SR_{V} determines the search range in the vertical direction. In an embodiment, the first reference block 220 refers to a portion of the reference frame which includes the collocated block of the first block 210 at the centre of the first reference block 220. In other embodiments, the first reference block 220 refers to a portion of the reference frame which includes the collocated block of the first block 210 at one of the corners of the first reference block 220. The reference block 220 and the first block 210 belong to different video frames. The reference block 220 includes only the reference data of the first block 210 in the reference frame. The collocated block of the first block 210 in the reference frame is the center of the block 220. The first reference block 220 is to include neighboring pixels of the collocated block of the first block for search purposes.

What to be processed next is a second block 215 which is horizontally adjacent to the first block 210 in the same row of an image. In order to process the second block 215, the second reference block (not shown) corresponding to the second block 215 needs to be available in the memory 200. The second reference block also has a size of SR_{H}+B_{H} by SR_{V}+B_{V}. Since there is a displacement of B_{H} between the first block 210 and the second block 215, the displacement between the first reference block 220 and the second reference block is B_{H}. The first SR_{H} columns of pixels in the second reference block overlaps with the last SR_{H} columns of pixels in the first reference block 220. Therefore, the first SR_{H} columns of pixels need not be loaded into the memory for the second reference block. The last SR_{H} columns of pixels in the first reference block 220 in the memory 200 are reused to form part of the reference block 220. Only the last B_{H} columns of pixels of the second reference block are required to be loaded into the memory 200. In an embodiment, these last B_{H} columns of pixels are to be loaded in a region 230 in the memory 200. When the last B_{H} columns of pixels 230 in the second reference block are loaded into the memory 200, they are appended to the last column of the first reference block 220. This results in that the memory 200 stores the image data with size of SR_{H}+2B_{H} by SR_{V}+B_{V}. In addition, the memory 200 has a buffer 240 which is available to hold data of size of SR_{H}+2B_{H} by IncPixLine.

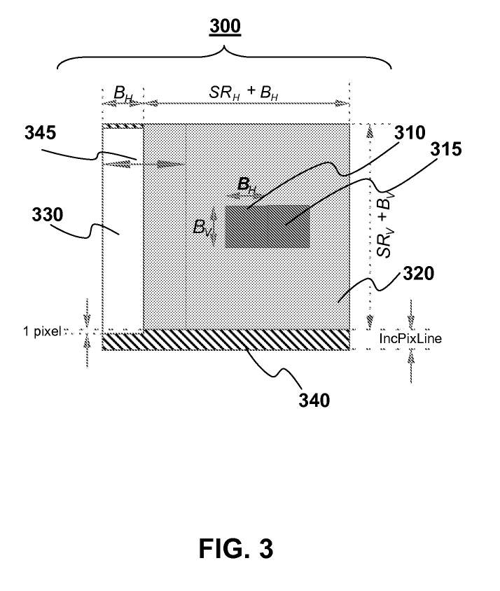

FIG. 3 shows an embodiment of using and loading data in a memory 300. When the memory 300 has been filled up with image data with size of SR_{H}+2B_{H} by SR_{V}+B_{V}, the current block which the processor is processing is a second block 310 and a second reference block 320 corresponding to that second block 310 is loaded into the memory 300. The second reference block 320 occupies the last SR_{H}+B_{H} columns of the memory 300. When the processor needs to process a subsequent block 315 adjacent to the second block 310, the subsequent reference block 315 to be loaded into the memory 300 requires an additional image data 330 with a size B_{H} by SR_{V}+B_{V}. The additional image data 330 represent the last B_{H} columns of the subsequent reference block. These last B_{H} columns of the subsequent reference block are those B_{H} by SR_{V}+B_{V} pixels adjacent to the second reference block 320 in the image. The additional image data 330 will be loaded into the first B_{H} columns of the memory 300 to replace the data existing in the memory 300. The additional image data 330 will start from the second row of the memory 300 rather the first row in the memory 300. When performing a raster scan to read the subsequent reference block for block 315, the processor will skip the first 2B_{H} pixels 345 in the first row of the memory 300 and start from the pixel in the 2B_{H}+1^{th} column in the first row of the memory 300. The memory 300 has a buffer 340 which is available to hold data of size of SR_{H}+2B_{H} by IncPixLine. IncPixLine refers to the an additional number of rows in the memory, for example, the value IncPixLine is approximately equal to (X/(SR_{H}+2B_{H})+0.5). Since the additional image data 330 occupies the B_{H} by SR_{V}+B_{V} in the first B_{H} columns starting from the second row of the memory 300, the last row of the additional image data 330 with a size of B_{H} pixels are required to be stored in the buffer 340.

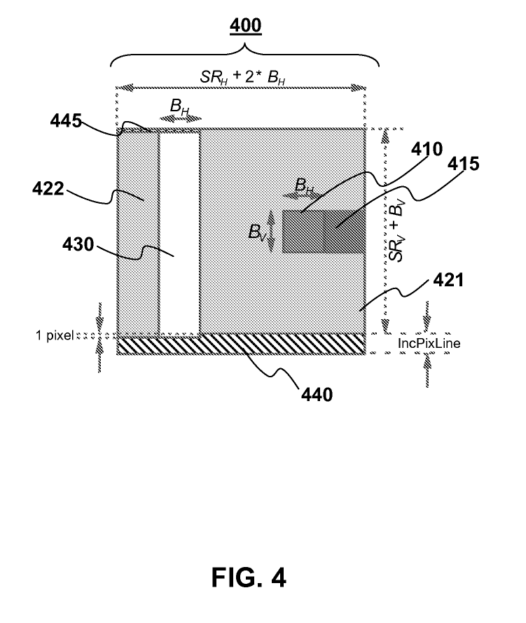

FIG. 4 shows an embodiment of using and loading data in a memory 400. The subsequent block 315 in FIG. 3 is shown as a third block 410 here. The third reference block for the third block 410 consists of a first region of 421 and a second region 422. The first region of 421 starts from the 2B_{H}+1^{th} pixel in the first row of the memory 400 and have a size of SR_{H} by SR_{V}+B_{V}, residing at the last SR_{H} columns of the memory 400. The second region 422 starts from the 1^{st} pixel in the second row of the memory 400 and have a size of B_{H} by SR_{V}+B_{V}, residing at the first B_{H} columns of the memory 400. When the data of the third reference block is required to be processed, the processor will read the data continuously in the memory 400 starting from the first row of the first region 421 and then the first row of the second region 422. The combination of the first row of the first region 421 and the first row of the second region 422 represents the first row of the third reference block. Similarly, the second row of the third reference block will be the combination of the second row of the first region 421 and the second row of the second region 422.

When a subsequent block 415 which is adjacent to the third block 410 is processed, the corresponding reference block is required to be loaded into the memory 400. Since the corresponding reference block overlaps with those in the last SR_{H} columns of the third reference block. Therefore, only an additional image data 430 with a size of B_{H} by SR_{V}+B_{V} is required to be loaded into the memory 400. The additional image data 430 will be appended adjacent to the second region 422 and loaded from the second row of the memory 400. This will leave a line of 2B_{H} pixels 445 in the first row of the memory 400. There is a buffer 440 in the memory 400. The buffer 440 has a size of SR_{H}+2B_{H} by IncPixLine. The buffer 440 has 2B_{H}×1 pixels which are used to store the image data of the last row of the second region 422 and the last row of the additional image data 430.

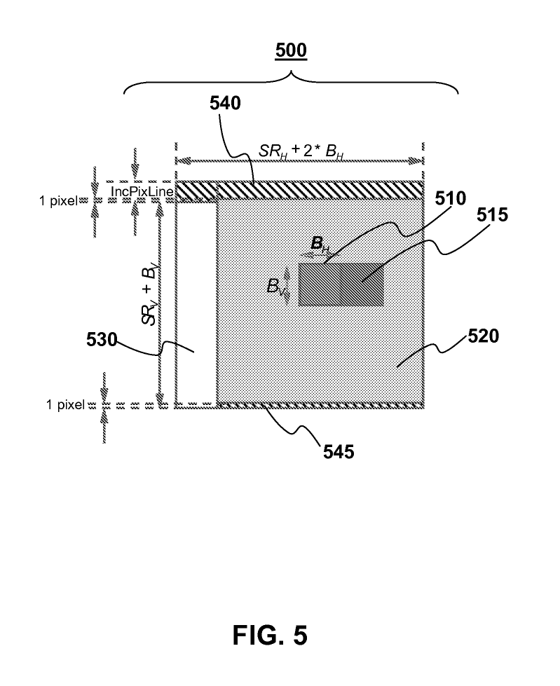

FIG. 5 shows an embodiment of using and loading data in a memory 500. The processor processed a N−1 block 510 and the N reference block 520 corresponding to the N block 515 is loaded into the memory 500. The reference block 520 starts from the IncPixLine−1^{th} row of the memory 500. This leaves an unused area 540 in the memory 500. When an image is processed block by block from left to right, the loading position of a corresponding reference block keep shifting downwards and using the buffer in the memory 500. As shown in previous embodiments, when the corresponding reference block is required to store in the memory 500 as a first region and a second region, the second region will start in a row subsequent to the first row of the first region. Therefore, if a subsequent block 515 which is adjacent to the N−1 block 510 is required to be processed, the corresponding reference block requires the subsequent B_{H} by SR_{V}+B_{V} pixels which is adjacent to the N−1 reference block 510 in the image. Instead of being appended to the N−1 reference block 510 along the same row, the additional image data 530 in size of B_{H} by SR_{V}+B_{V} are loaded at the next address of the reference block of block 500 with a shift of 1 pixel downwards because there is no more room in the memory 500 for such appending. As an embodiment, the buffer 545 of the memory 500 is sufficiently large enough to allow the loading of corresponding reference block of all the blocks along a line of an image to complete before the loading of the corresponding reference block of the first block in a subsequent line of image start from the first row and the first column in the memory. At that time, apart from the first SR_{H}+B_{H} by SR_{V}+B_{V} is reserved for such loading, the remaining region in the memory 500 will be free for loading new data again.

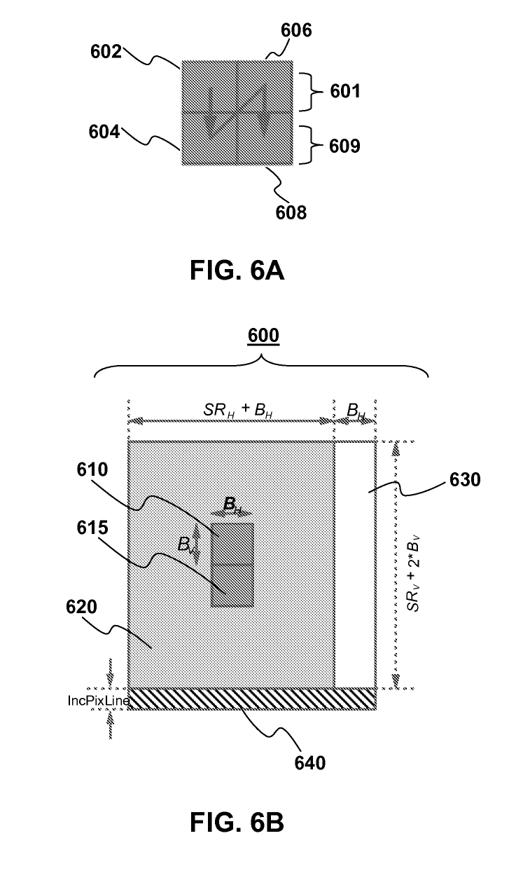

FIG. 6A shows a portion of a frame divided into blocks. A frame is processed block by block. This portion of a frame has an upper row 601 and a lower row 609. Each row of a frame contains N blocks but only the first two blocks are shown in this exemplary figure. In an embodiment, instead of processing blocks row by row in a frame, a first block 602 in the upper row 601 is processed and then a first block 604 in the lower row 609 is processed. Subsequently, a second block 606 in the upper row 601 is processed and then a second block 608 in the lower row 609 is processed.

FIG. 6B shows a further embodiment of using and loading data in a memory 600. The processor will process a first block 610 and subsequent a second block 615 which is directly beneath the first block 610. The size of the first block 610 and the second block 615 are both equal to B_{H} by B_{V}. The corresponding reference block 620 for both the first block 610 and the second block 615 will be a portion of SR_{H}+B_{H} by in size SR_{V}+2B_{V} in an image. The corresponding reference block 620 is loaded at a time. Alternatively, the first SR_{V}+B_{V} rows of the corresponding reference block 620 are loaded into the memory 600 for processing the first block 610 first. Then when the second block 620 is required to be processed, the last Bᵥ rows are loaded into the memory 600. There is a buffer 640 in size of SR_{H}+2B_{H} by IncPixLine in the memory 600.

When the blocks adjacent to the first block 610 and the second block 620 are processed, the reference blocks corresponding to the subsequent blocks are required to be loaded into the memory 600. Most of the data of these reference blocks are found in the reference block 620. Only additional image data in size of B_{H} by SR_{V}+2B_{V} are required to be loaded into the memory 600 and appended to the last column of the reference block 620.

In this embodiment, the size of the memory 600 is SR_{H}+2B_{H} by SR_{V}+2B_{V} together with the buffer size SR_{H}+2B_{H} by IncPixLine. If more blocks along the same columns are required to be loaded at one time to reduce the bandwidth, more space are required in the memory 600 to hold the data for a plurality of corresponding reference blocks simultaneously.

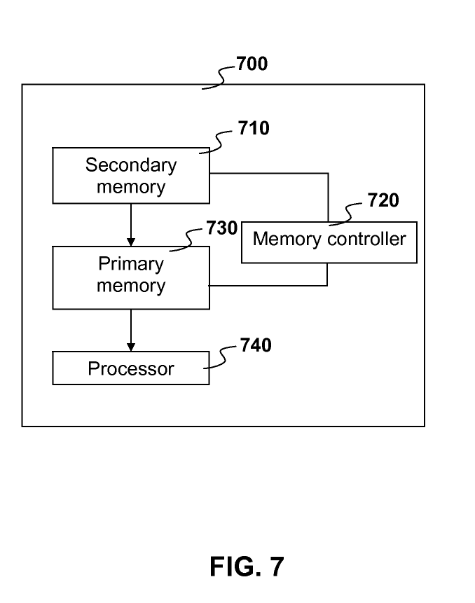

FIG. 7 shows an apparatus 700 which implements the method of memory usage as described above. In an embodiment, the apparatus is implemented in a video encoder. The apparatus 700 contains a secondary memory 710 which stores one or more frames of a video. The apparatus 700 contains a processor 740 which performs a number of control and processing functions. The apparatus 700 contains a primary memory 730 which is loaded with data for the processor 740 to process. When the processor 740 processes each frame of video block by block, only the necessary data are loaded from the secondary memory 710 to the primary memory 720 according to the method as described above. As long as the data required are available in the primary memory 730, these existing data will be reused rather than being reloaded from the secondary memory 710. Only the additional image data are required to be loaded into the primary memory 730. The apparatus 700 contains a memory controller 720 to control the reading and loading of data in the primary memory 730 as well as the secondary memory 740. In another embodiment, the processor 740 also performs the functions of the memory controller 720 and is used to replace the memory controller 720.

The description of preferred embodiments of this claimed invention are not exhaustive and any update or modifications to them are obvious to those skilled in the art, and therefore reference is made to the appending claims for determining the scope of this claimed invention.

### INDUSTRIAL APPLICABILITY

The claimed invention has industrial applicability in consumer electronics, in particular with video applications. The claimed invention can be used in a video encoder, and in particular, in a multi-standard video encoder. The multi-standard video encoder implements various standards such as H.263, H.263+, H.263++, H264, MPEG-1, MPEG-2, MPEG-4, AVS (Audio Video Standard) and the like. More particularly, the claimed invention is implemented for a DSP (digital signal processing) video encoder, for example, Davinci-6446 based H.264 encoder. The claimed invention can be used not only for software implementation but also for hardware implementation. For example, the claimed invention can be implemented in FPGA chip or SoC ASIC chip.

What is claimed is:

1. A method of reusing memory for motion estimation, comprising:
replacing, by a processor, at least a portion of a preexisting reference block in a memory with additional image data;
loading, by the processor, said additional image data into said memory with a displacement from a start address of said preexisting reference block;
forming, by the processor, one or more reference blocks from said additional image data and said preexisting reference block; and
retrieving, by the processor, said one or more reference frames from a plurality of continuous data addresses.

2. The method of reusing memory for motion estimation as claimed in claim 1, wherein:
said displacement is a memory size for holding a row of a reference block.

3. The method of reusing memory for motion estimation as claimed in claim 1, wherein:
said additional image data is a plurality of starting columns of a reference block.

4. The method of reusing memory for motion estimation as claimed in claim 1, wherein:
said plurality of starting columns have a width of a width of a block.

5. A memory controller for motion estimation, comprising:
a processor replacing at least a portion of a preexisting reference block in a memory with additional image data;
said processor loading said additional image data into said memory with a displacement from a start address of said preexisting reference block;
said processor forming one or more reference blocks from said additional image data and said preexisting reference block; and
said processor retrieving said one or more reference frames from a plurality of continuous data addresses.

6. The memory controller for motion estimation as claimed in claim 5, wherein:
said displacement is a memory size for holding a row of a reference block.

7. The memory controller for motion estimation as claimed in claim 5, wherein:
said additional image data is a plurality of starting columns of a reference block.

8. The memory controller for motion estimation as claimed in claim 5, wherein:
said plurality of starting columns have a width of a width of a block.
